(19) United States
(12) Patent Application Publication
(10) Pub. No.: US 2008/0052995 A1
(43) Pub. Date: Mar. 6, 2008

(54) Gasification apparatus for atmospheric liquid fuel

(76) Inventor: Chia-Chen Wen, Sijhih City (TW)

Correspondence Address: BIRCH STEWART KOLASCH & BIRCH, PO BOX 747, FALLS CHURCH, VA, 22040-0747, US

(21) Appl. No.: 11/892,116

(22) Filed: Aug. 20, 2007

(30) Foreign Application Priority Data
Aug. 22, 2006 (TW) 095130932

(51) Int. Cl. B01F 3/04

(52) U.S. Cl. 48/186; 239/9

(57) ABSTRACT

A gasification apparatus for atmospheric liquid fuel, primarily comprising: a fuel tank, a gasification vessel, an air pump, a low-frequency generator, and a gaseous fuel output pipe, wherein the gasification vessel further comprises a gasification plate and the low-frequency generator adds a low-frequency oscillatory wave into an air introduced into the gasification plate by the air pump so that air bubbles output by the gasification plate impact mutually and break sequentially so as to generate natural ultrasonics in a liquid fuel and thereby gasify the liquid fuel.

### BACKGROUND OF THE INVENTION

1. Technical Field

The present invention relates to liquid fuel gasification apparatuses, and more particularly, to a gasification apparatus for atmospheric liquid fuel.

2. Description of Related Art

Fuel is indispensable to modern human life. Therefore, the issue of how to provide fuel with high stability, safety, and environmental friendliness has been popularly concerned. Conventionally, in an engine, fuel is directly nebulized, sparged and burned. As by this means, fuel is not completely burned, it disadvantageously causes waste of energy resources and air pollution. On the contrary, gasified fuel can be completely burned so has the advantages of energy-saving and environmental friendliness. For instance, the existing LPG (Liquefied Petroleum Gas) hybrid car operated by burning gaseous fuel is a symbol of energy-saving and environmental friendliness. However, such LPG hybrid cars have not been extensively accepted because the aforementioned gaseous fuel is substantially a compressed air that may possibly cause danger in manifold aspects. Thus, one attempt to solve the problem of conventional storage method for compressed fuel is provided in Taiwan Design Patent Application 089216244. The construction of the container for non-compressed liquid fuel disclosed in Taiwan Design Patent Application 089216244 will be described hereinafter.

The prior art has a container, that includes three layers of accommodating rooms vertically arranged, which are an upper accommodating room, a middle accommodating room and a lower accommodating room from top to bottom. The middle accommodating room further comprises a container conduit communicated with the upper accommodating room and the lower accommodating room.

An air supply device comprises an air compressor deposited in the lower accommodating room, a pressure switch deposited in the upper accommodating room, an inner conduit settled inside the container conduit, having one end connected with the pressure switch while an opposite end connected with the air compressor, a check valve deposited in the upper accommodating room, an air-out conduit connected with the pressure switch and one end of the check valve, and an air-in conduit connected having one end connected with an opposite end of the check valve while an opposite end communicated to a bottom of the middle accommodating room. The ventilation device further includes a gaseous fuel piping devices, containing a gaseous fuel inlet having one end opened to the middle accommodating room while an opposite end connected with a relief valve, a rotary switch provided on the relief valve, a gaseous fuel outlet, and an adjusting valve connected between the gaseous fuel outlet and the relief valve.

The container also has an ultrasonic generator arranged properly in the lower accommodating room and a power switch linked with the pressure switch as well as the air compressor.

Thereupon, the ultrasonic generator in the lower accommodating room energizes air delivered by the air compressor to oscillate, so that when the oscillating air contacts an atmospheric liquid fuel in the middle accommodating room, molecules of the liquid fuel can be activated and transported to a top portion of the middle accommodating room for being received by the gaseous fuel inlet of the gaseous fuel piping devices. Afterward, when the rotary switch is turned on, the molecules of the liquid fuel can be conveyed through the relief valve and the adjusting valve to the gaseous fuel outlet by the air.

While the described container for non-compressed liquid fuel is realized, how to simplify the complicated structure; enhance the efficiency and safety of gasification; and present improved economic effect of fuel are still the concerns of the inventor of the present invention.

### SUMMARY OF THE INVENTION

The present invention has been accomplished under these circumstances in view. It is one objective of the present invention to provide a gasification apparatus for atmospheric liquid fuel that comprises at least a fuel tank, a gasification vessel, an air pump, a low-frequency generator, and a gaseous fuel output pipe. Therein the gasification vessel further comprises a gasification plate. The low-frequency generator imparts air introduced into the gasification plate by the air pump with a low-frequency oscillatory wave ranging between 100 HZ and 120 HZ. Thereby, air bubbles output by the gasification plate can mutually impact and sequentially break so as to generate natural ultrasonics in the liquid fuel. The gasification apparatus of the present invention implements an atmospheric liquid fuel having a final boiling point ranging between 60° C. and 130° C. Therefore, the present invention facilitates avoiding the potential danger of compressed air. Also, as the instantaneously gasified liquid fuel can be completely burned by an engine, the present invention possesses the advantages of energy-saving, environmental friendliness, safety and convenience.

### BRIEF DESCRIPTION OF THE DRAWINGS

The invention as well as a preferred mode of use, further objectives and advantages thereof, will best be understood by reference to the following detailed description of an illustrative embodiment when read in conjunction with the accompanying drawings, wherein:

FIG. 1 is a schematic drawing showing the structure of the present invention.

### DETAILED DESCRIPTION OF THE PREFERRED EMBODIMENT

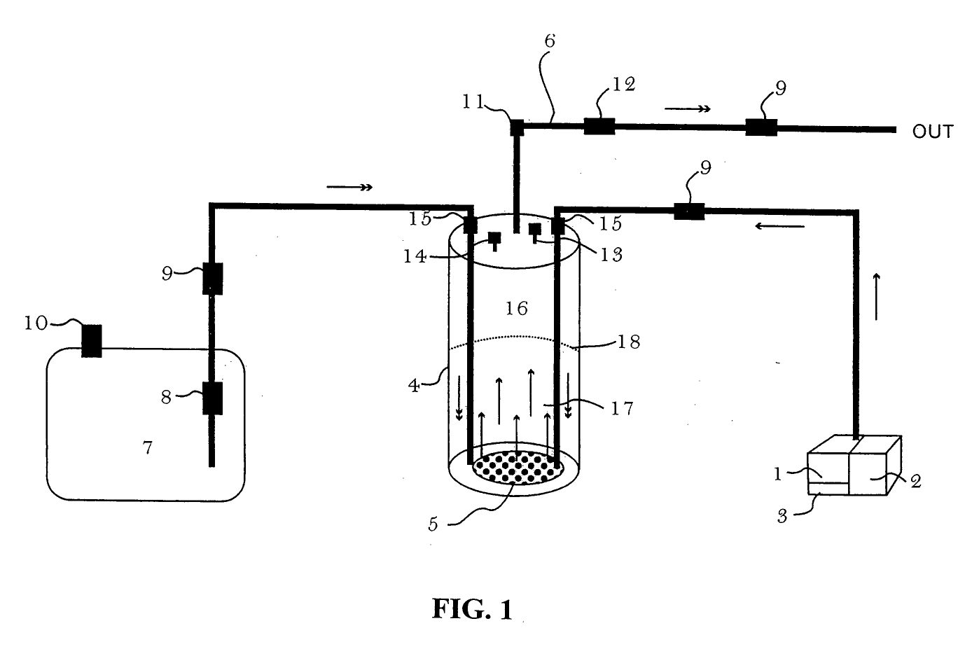

To achieve these and other objectives of the present invention, one embodiment of the gasification apparatus for atmospheric liquid fuel according to the present invention is herein provided. FIG. 1 is a schematic drawing showing the structure of the present invention. As illustrated in the drawing, the disclosed subject matter comprises the following primary components, which will be recited in an order from right to left. These primary components are an air pump 1, a low-frequency generator 2, a gasification vessel 4, a gasification plate 5, a gaseous fuel output pipe 6, and a fuel tank 7.

Therein, the low-frequency generator 2 and the air pump 1 are integrated as an assembly to be driven by an AC or DC power supply device 3. The said assembly can generate an air having a pressure ranging between 0.08 kg/cm² and 0.3 kg/cm². The generated low-frequency air comprises an oscillatory wave ranging between 100 HZ and 120 HZ.

The air containing the oscillatory wave then passes through a conduit, a control valve (such as a solenoid valve 9) and a check valve 15. Finally, the air is introduced into the gasification plate 5 at a bottom of an airtight receptacle (such as a gasification vessel 4).

Size and shape of the gasification vessel 4 may be varied according to needs of a practical field where the disclosed subject matter is used.

The gasification plate 5 is substantially a plate having a hollow internal part. Numerous fine pores are distributed thereon. Size and shape of the pores may be varied according to those of the gasification vessel 4.

The fuel tank 7 (may be an innate gasoline tank of a car) can receive fuel of a required quantity through an oil filler point 10. An oil pump 8 automatically draw the fuel so that the fuel can pass an oil pipe, the control valve (the solenoid valve 9), as well as the check valve 15 to be poured into the gasification vessel 4 for gasification.

Therein, to meet a required quantity of the fuel in the gasification vessel 4, a liquid level sensor 14 may be implemented to control the drawing of the oil pump 8.

After the liquid fuel 17 poured into the gasification vessel 4 reaches a proper liquid level 18, the air containing the oscillatory wave is introduced into the gasification plate 5. Thereupon, the fine pores distributed overall the gasification plate 5 produce several hundred thousand small air bubbles that contain the oscillatory wave ranging between 100 HZ and 120 HZ every second. When the air bubbles impact mutually and break sequentially, natural ultrasonics is generated in the liquid fuel. Thus, energy of ultrasonics can instantaneously gasify the liquid fuel 17 into gaseous oil molecules. At this time, the air possessing the pressure ranging between 0.08 kg/cm² and 0.3 kg/cm², which is previously introduced in, facilitates outputting the gaseous oil molecules of combustible air 16 in the gasification vessel 4 through an air outlet at a top thereof. Then the outputted gaseous oil molecules can pass through an air outlet valve 11, the gaseous fuel output pipe 6, a regulator 12, the solenoid valve 9, and an output end OUT for entering the engine so as to be provided to the engine as a fuel material thereof.

Although a particular embodiment of the invention has been described in detail for purposes of illustration, it will be understood by one of ordinary skill in the art that numerous variations will be possible to the disclosed embodiments without going outside the scope of the invention as disclosed in the claims.

What is claimed is:

1. A gasification apparatus for atmospheric liquid fuel, primarily comprising: a fuel tank, a gasification vessel, an air pump, a low-frequency generator, and a gaseous fuel output pipe, wherein the gasification vessel further comprises a gasification plate and the low-frequency generator adds a low-frequency oscillatory wave into an air introduced into the gasification plate by the air pump so that air bubbles output by the gasification plate impact mutually and break sequentially so as to generate natural ultrasonics in a liquid fuel and thereby gasify the liquid fuel.

2. The gasification apparatus of claim 1, wherein the low-frequency oscillatory wave has a frequency ranging between 8 HZ and 300 HZ.

3. The gasification apparatus of claim 1, wherein the air pump and the low-frequency generator are electrically supported by an AC/DC power supply device.

4. The gasification apparatus of claim 1, wherein the gasified liquid fuel has a pressure ranging between 0.01 kg/cm² and 0.9 kg/cm².

5. The gasification apparatus of claim 1, wherein the gasification plate generates at least one hundred thousand air bubbles that contain the oscillatory wave every second.

6. The gasification apparatus of claim 1, wherein the gasification plate is in a round shape or any shape according to a shape of the gasification vessel.

7. The gasification apparatus of claim 1, wherein the gasification plate has a hollow internal part and numerous fine pores are distributed overall the gasification plate.

8. The gasification apparatus of claim 1, wherein a required quantity of the fuel in the gasification vessel is detected by a liquid level sensor.

9. The gasification apparatus of claim 1, wherein the atmospheric liquid fuel implemented by the gasification apparatus has a final boiling point ranging between 40° C. and 230° C.
